(19) United States
(12) Patent Application Publication
(10) Pub. No.: US 2019/0207690 A1
(43) Pub. Date: Jul. 4, 2019

(54) An arrangement for CATV network segmentation

(71) Applicant: Teleste Oyj, Littoinen (FI)

(72) Inventors: Kari Mäki, Turku (FI); Olli Leppänen, Ruutana (FI); Perttu Fagerlund, Turku (FI)

(73) Assignee: Teleste Oyj, Littoinen (FI)

(21) Appl. No.: 16/332,824

(22) PCT Filed: Sep. 14, 2016
(86) PCT No.: PCT/FI2016/050638

§ 371 Date: Mar. 13, 2019

(51) Int. Cl. H04H 20/78; H04N 7/10; H04L 12/28

(52) U.S. Cl. CPC H04H 20/78; H04L 12/2801; H04N 7/104

(57) ABSTRACT

A network element of a cable television (CATV) network, said network element comprising a distributed access node comprising a core network interface for receiving a plurality of broadcast multiplexes; means for dividing the plurality of broadcast multiplexes into at least a first transmission content and a second transmission content, wherein the first and the second transmission content comprise at least partly different multiplexes; and means for transmitting the first transmission content to a first network segment and the second transmission content to a second network segment.

### FIELD OF THE INVENTION

The invention relates to cable television (CATV) networks, and especially to network segmentation.

### BACKGROUND OF THE INVENTION

CATV networks may be implemented with various techniques and network topologies, but currently most cable television networks are implemented as so-called HFC networks (Hybrid Fiber Coax), i.e. as combinations of a fibre network and a coaxial cable network. FIG. 1 shows the general structure of a typical HFC network. Program services are introduced from the main amplifier 100 (a so-called headend) of the network via an optical fibre network 102 to a fibre node 104, which converts the optical signal to an electric signal to be relayed further in a coaxial cable network 106. Depending on the length, branching, topology, etc. of the coaxial cable network, this coaxial cable segment typically comprises one or more broadband amplifiers 108, 110 for amplifying program service signals in a heavily attenuating coaxial media. From the amplifier the program service signals are introduced to a cable network 112 of a smaller area, such as a distribution network of an apartment building, which are typically implemented as coaxial tree or star networks comprising signal splitters for distributing the program service signals to each customer. From a wall outlet the signal is further relayed either via a cable modem 114 to a television receiver 116 or a computer 118, or via a so-called set-top box 120 to a television receiver 122.

Data Over Cable Service Interface Specification (DOCSIS) is a CATV standard providing specifications for high-bandwidth data transfer in an existing CATV system. The latest version DOCSIS 3.1 enables the cable network operators to maximize both the downstream and upstream data throughput using the existing HFC networks. One important issue in improving the performance of the CATV networks is the segmentable network nodes, i.e. the CATV network is divide into ever smaller segments and the segmentable node may provide each network segment with at least partly different content, depending on customer orders.

One issue relating to the introduction of DOCSIS 3.1 is the concept of Distributed CCAP Architecture (DCA), where some features of the headend are distributed to the network elements closer to the customers. DOCSIS 3.1 specifies at least two distributed network nodes, i.e. a Remote PHY Device (RPD) and a Remote-MACPHY Device (RMD).

However, while providing scale advantages and flexible deployment options by maximizing the channel capacity, the usage of DCA may limit the segmentation. The contemporary RPD/RMD modules are specified to contain only one content service group, which means that one RPD/RMD module supports only one RF downstream segment. Thus, the DCA products according to such specifications will only split the same content into two or more segments, and consequently real segmentation with different contents is not achieved.

### BRIEF SUMMARY OF THE INVENTION

Now, an improved arrangement has been developed to reduce the above-mentioned problems. As aspects of the invention, we present a network element of a cable television network, which is characterized in what will be presented in the independent claims.

The dependent claims disclose advantageous embodiments of the invention.

According to an aspect of the invention, there is provided a network element of a cable television (CATV) network, said network element comprising a distributed access node comprising a core network interface for receiving a plurality of broadcast multiplexes; means for dividing the plurality of broadcast multiplexes into at least a first transmission content and a second transmission content, wherein the first and the second transmission content comprise at least partly different multiplexes; and means for transmitting the first transmission content to a first network segment and the second transmission content to a second network segment.

According to an embodiment, said means for transmitting the content comprise a first transmission port for the first network segment and a second transmission port for the second network segment and at least one modulator for modulating the first and the second transmission to same frequency band.

According to an embodiment, the first and the second transmission content comprise at least one common multiplex.

According to an embodiment, the at least one common multiplex is a DVB-C multiplex.

According to an embodiment, the at least partly different multiplexes of the first and the second transmission content comprise DOCSIS multiplexes.

According to an embodiment, the first and the second transmission content are provided with RF overlay content.

According to an embodiment, the network element comprises a splitter for dividing the RF overlay content into two similar signals; and a first combiner for combining a divided RF overlay signal with the first transmission content and a second combiner for combining a divided RF overlay signal with the second transmission content.

These and other aspects, embodiments and advantages will be presented later in the detailed description of the invention.

### BRIEF DESCRIPTION OF THE DRAWINGS

The invention will now be described in more detail in connection with preferred embodiments with reference to the appended drawings, in which:

FIG. 1 shows the general structure of a typical HFC network;

FIG. 2 shows a simplified block chart of a network element operating according to prior art; and

FIG. 3 shows a simplified block chart of a network element operating according to an embodiment of the invention.

### DETAILED DESCRIPTION OF THE EMBODIMENTS

Data Over Cable Service Interface Specification (DOCSIS) is a CATV standard providing specifications for high-bandwidth data transfer in an existing CATV system. DOCSIS may be employed to provide Internet access over existing hybrid fiber-coaxial (HFC) infrastructure of cable television operators. DOCSIS has been evolved through versions 1.0, 1.1, 2.0 and 3.0 to the latest version of 3.1. DOCSIS provides a lucrative option for cable network providers to maximize both the downstream and upstream data throughput using the existing cable TV network, but without making expensive changes to the HFC network infrastructure.

When implementing the HFC network of FIG. 1 according to DOCSIS, the headend 100 of the CATV network comprises inputs for signals, such as TV signals and IP signals, a television signal modulator and a cable modem termination system (CMTS). The CMTS provides high-speed data services to customers thorough cable modems (CM; 114) locating in homes. The CMTS forms the interface to the IP-based network over the Internet. It modulates the data from the Internet for downstream transmission to homes and receives the upstream data from homes. The CMTS additionally manages the load balancing, error correction parameters and the class of service (CoS).

Signals from the headend 100 are distributed optically (fiber network 102) to the vicinity of individual homes, where the optical signals are converted to electrical signals at the terminating points 104. The electrical signals are then distributed to the various homes via the existing 75 ohm coaxial cables 106. The maximum data transfer of the coaxial cables is limited due to strong frequency-based attenuation. Therefore, the electrical signals transmitted over coaxial cables must be amplified. The amplifiers 108, 110 used for this purpose are suited to a specific frequency range. In addition, the upstream and downstream must occur over the same physical connection. The last part 112 of the coaxial connection between the CMTS and the CMs branches off in a star or a tree structure. A CMTS transmits the same data to all CMs located along the same section of cable (one-to-many communications). A request/grant mechanism exists between the CMTS and the CMs, meaning that a CM needing to transmit data must first send a request to the CMTS, after which it can transmit at the time assigned to it.

Depending on the version of DOCSIS used in the CATV network, there is a great variety in options available for configuring the network. For the downstream channel width, all versions of DOCSIS earlier than 3.1 use either 6 MHz channels (e.g. North America) or 8 MHz channels (so-called “EuroDOCSIS”). However, the upstream channel width may vary between 200 kHz and 3.2 MHz (versions 1.0/1.1), and even to 6.4 MHz (version 2.0). 64-QAM or 256-QAM modulation is used for downstream data in all versions, but upstream data uses QPSK or 16-level QAM (16-QAM) for DOCSIS 1.x, while QPSK, 8-QAM, 16-QAM, 32-QAM, 64-QAM and 128-QAM are used for DOCSIS 2.0 & 3.0.

DOCSIS 3.1 specifications support capacities of at least 10 Gbit/s downstream and 1 Gbit/s upstream using 4096 QAM. DOCSIS 3.1 rejects the 6 or 8 MHz wide channel spacing and uses narrower orthogonal frequency-division multiplexing (OFDM) subcarriers being 20 kHz to 50 kHz wide, which sub-carriers can be combined within a block spectrum of about 200 MHz wide.

DOCSIS 3.1 further provides the concept of Distributed CCAP Architecture (DCA). Converged Cable Access Platform (CCAP) may be defined as an access-side networking element or set of elements that combines the functionality of a CMTS with that of an Edge QAM (i.e. the modulation), providing high-density services to cable subscribers. Conventionally, the CCAP functionalities have been implemented in the headend/hub, such as the headend 100 in FIG. 1. In a DCA, some features of the CCAP are distributed from headend/hub to the network elements closer to the customers, for example to the fibre nodes 104 in FIG. 1. DOCSIS 3.1 specifies at least two network element concepts, i.e. a Remote PHY Device (RPD) and a Remote-MACPHY Device (RMD), to which some functionalities of the headend can be distributed.

The data transmission between the distributed parts of the CCAP is typically carried out through a fiber connection. This may provide both scale advantages and flexible deployment options by maximizing the channel capacity and simplifying many operations via the usage of digital fiber and Ethernet transport.

In traditional HFC transmission it is common to work with segmentable nodes. When more DOCSIS capacity is needed, the forward and/or return paths are segmented to accommodate more data channels per segment. The segmentation is achieved by network nodes having a plurality of RF/optical ports and dedicated downstream receivers, thus enabling dedicated DOCSIS segments.

When distributed access devices, such as RPD/RMD, are introduced, segmentation becomes more complex. There are several issues that make the implementation of such products problematic.

Limitations of current HFC nodes do not allow more than one RPD/RMD module used in a HFC node. For example, the power consumption of an RPD/RMD module is so high that the resulted heat cannot be dissipated by the heat dissipation capacity of a HFC node. Moreover, the housings of contemporary HFC nodes allow only one RPD/RMD module to be inserted. What is more problematic is that nowadays RPD/RMD modules are specified to contain only one service content group, i.e. a set of downstream channels from a common MAC Domain or the same CMTS port. As a result, one RPD/RMD module supports only one RF downstream segment. Thus, the DCA products according to such specifications will split the same RPD/RMD module content into two or more segments, and consequently real segmentation with different contents is not achieved as can be the case with the traditional HFC approach.

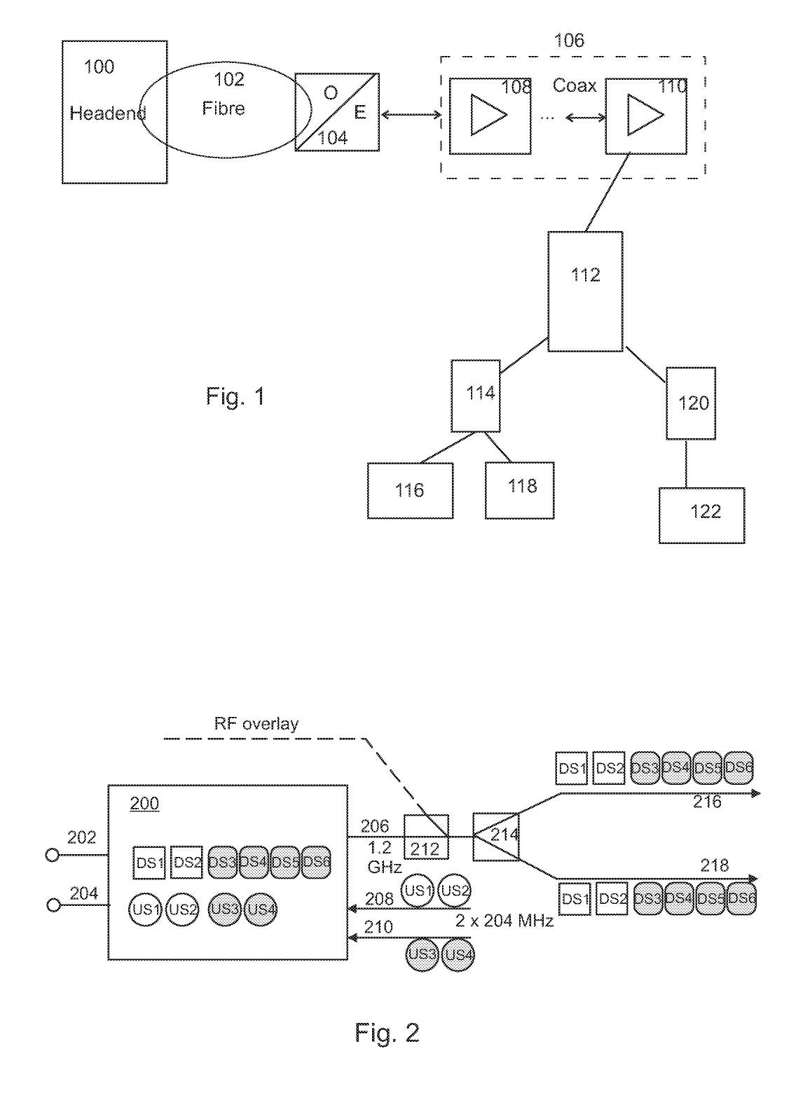

The problem can be further illustrated by referring to FIG. 2, which shows a typical way of dividing the RPD/RMD content into two segments as currently specified.

The HFC node 200 provided with a RPD/RMD module receives content from the core network, i.e. originally from the headend. The core network interface 202 may be, for example, a 10 Gbit Ethernet or a 10 Gbit xPON connection. The second core interface 204 may be used for redundancy and/or daisy chaining purposes. In most of the current HFC networks, the downstream path 206 is frequency-limited such that the upper frequency edge is limited to, for example, 862 MHz or 1006 MHz, in any case typically below 1.2 GHz.

In FIG. 2, the downstream service content group is illustrated as two DVB-C multiplexes (DS1, DS2; rectangular boxes referring to DVB-C) and two DOCSIS multiplexes (DS3, DS4; rounded shadowed boxes). Two further multiplexes (DS5, DS6; rounded shadowed boxes) may contain either DVB-C or DOCSIS transmissions. The bandwidth of one multiplex may at maximum be 192 MHz, but depending on network configuration it may also be smaller, for example a multiple of 24 MHz. The total size of such content may at maximum be about 8.5 Gbit, which is still transmittable via the core network 10 Gbit capacity. The downstream content is transmitted via the downstream port. The upstream content comprises two DVB-C transmissions 208 (US1; US2) and two DOCSIS transmissions 210 (US3; US4), which are received through two dedicated 204 MHz upstream ports.

Herein, DVB-C may refer, for example, to SC-QAM channel for video services in accordance with downlink cable standards DVB-C EN 300 429 and ITU J.83 Annex A, Annex B or other system.

In many countries, the cable operators supply the CATV transmission with RF overlay signals, which may comprise analog TV signals, satellite TV signals, locally generated content, etc. Provided that the forward path for downstream transmissions has 1.2 GHz bandwidth, some RF overlay content may be combined, in addition to the six DVB-C/DOCSIS multiplexes, to the downstream transmission, for example in a combiner 212.

However, only one downstream service content group operated by the RPD/RMD module limits the segmentation to such solution that the downstream transmission is split, for example in splitter 214, into two or more segments 216, 218 each having the same content. In other words, the same content is delivered to each client connected to the RPD/RMD module despite of what services they have ordered. It is evident that the performance of such segmentation is poor in terms of flexibility and transmission capacity.

On the other hand, data processing capacity of an RPD/RMD module would be enough to more than one segment, especially when RF overlay is present and/or upper frequency is below 1.2 GHz such as in the frequency restricted networks, today often 862/1006 MHz networks.

Consequently, an improved arrangement is presented herein for segmenting the RPD/RMD content into a plurality of segments in more flexible way.

According to an aspect, a network element of a cable television (CATV) network is now introduced, said network element comprising a distributed access node comprising a core network interface for receiving a plurality of broadcast multiplexes; means for dividing the plurality of broadcast multiplexes into at least a first transmission content and a second transmission content, wherein the first and the second transmission content comprise at least partly different multiplexes; and means for transmitting the first transmission content to a first network segment and the second transmission content to a second network segment.

Thus, the distributed access node, such as a node with a RPD/RMD module, is modified such that it is capable of transmitting at least partly different content to a plurality of network segments, thereby improving the flexibility and the transmission performance of the segmentation. The benefits of the arrangement are most prominent in frequency-limited network configurations, where the transmission capacity of the network segments is smaller than the maximum output capacity of the RPD/RMD module, wherein the bandwidth required by the possible RF overlay signal must be taken into account.

According to an embodiment, said means for dividing the plurality of broadcast multiplexes comprise a Field-Programmable Gate Array (FPGA) circuit. The flexibility in programming FPGAs facilitates the conversion process of the current RPD/RMD modules specified to contain only one downstream port to be capable of transmitting different content to different network segments. A skilled person appreciates that ASIC or other similar means may be used for dividing the plurality of broadcast multiplexes, as well.

According to an embodiment, said means for transmitting the content comprise a first transmission port for the first network segment and a second transmission port for the second network segment and at least one modulator for modulating the first and the second transmission to said same frequency band.

As a result, in the distributed access node, such as a node with a RPD/RMD module, all the node ports (segments) would accommodate dedicated forward modulators and return path receivers. This would allow flexibility and maximal performance per segment.

According to an embodiment, the first and the second transmission content may comprise at least one common multiplex. According to an embodiment, the at least one common multiplex may be a DVB-C multiplex.

Thus, typically the DVB-C transmissions in CATV networks are intended to all customers. Depending on the network configuration, one or more common DVB-C multiplexes are transmitted to all segments. According to an embodiment, the at least partly different multiplexes of the first and the second transmission content may comprise DOCSIS multiplexes.

According to an embodiment, the first and the second transmission content are provided with RF overlay content. Depending on the network configuration and the bandwidth required for transmitting the DVB/DOCSIS multiplexes, there may be bandwidth available in the network segments for the RF overlay content. Similarly to the DVB-C content, the RF overlay content is typically also intended to all customers. Thus, the same RF overlay content may be provided to all segments.

According to an embodiment, in addition or alternatively to DOCSIS multiplexes, the at least partly different multiplexes of the first and the second transmission content may comprise DVB-C multiplexes and/or RF overlay content.

According to an embodiment, the network element comprises a splitter for dividing the RF overlay content into two similar signals; and a first combiner for combining a divided RF overlay signal with the first transmission content and a second combiner for combining a divided RF overlay signal with the second transmission content.

Hence, the RF overlay content, regardless of its origin, may be supplied to a splitter, which divides the RF overlay signal into two or more RF overlay signals with similar content. In each transmission segment, the divided RF overlay signal may be combined with the segment-specific multiplex content. However, it is also possible that the first and the second transmission content are provided with different RF overlay content. In such case, no splitter for dividing the RF overlay content is needed.

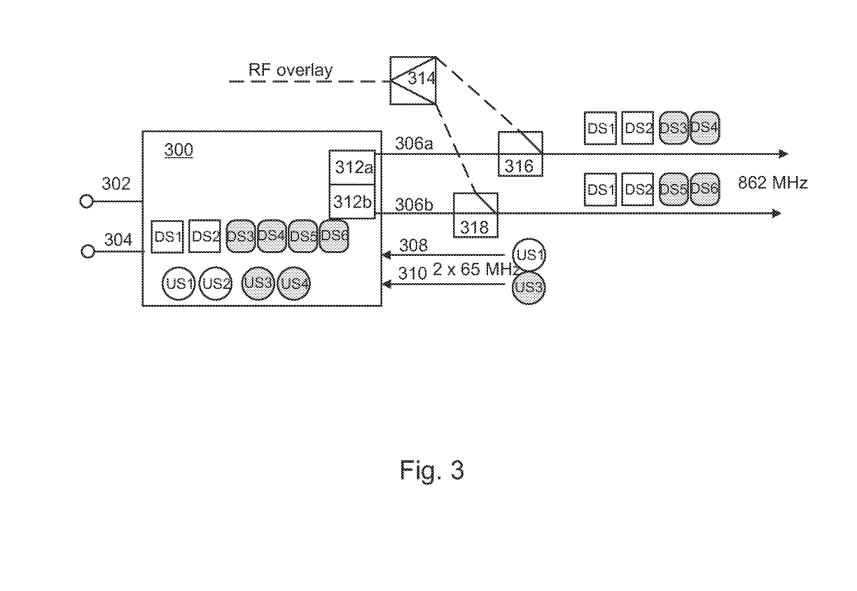

The embodiments may be illustrated by referring to FIG. 3, which shows a simplified block chart of a network element (HFC node, 300) dividing the RPD/RMD capacity into two segments with different content.

The core network interface 302, 304 of the HFC node is similar to that of FIG. 2, i.e. a 10 Gbit Ethernet or a 10 Gbit xPON connection. Also, the downstream content is similar to that of FIG. 2, i.e. two DVB-C multiplexes (DS1, DS2), two DOCSIS multiplexes (DS3, DS4) and two further either DVB-C or DOCSIS multiplexes (DS5, DS6)

However, the downstream path of the HFC node in FIG. 3 is frequency-limited such that the upper frequency edge is limited to 862 MHz, thereby illustrating the applicability of the embodiments particularly to such network segments where the transmission capacity of the network segment is smaller than the maximum output capacity of the RPD/RMD module.

Due to the frequency limitations, the bandwidth of the upstream return path is also limited. Therefore, the upstream content comprises only one DVB-C transmission 308 (US1) and one DOCSIS transmission 310 (US3), which are received through two dedicated 65 MHz upstream ports.

Now the downstream transmission is divided into two segments 306a, 306b having different content. The HFC node containing the RPD/RMD module is provided with at least two dedicated ports 312a, 312b, both capable of supplying a downstream transmission up to 862 MHz. The ports are content-dedicated ports such that at least partly different content can be supplied in the different segments by the ports, preferably at the same transmission bandwidth. As mentioned above, the ports may be implemented, for example, as a FPGA or an ASIC circuit enabling the division of the content and simultaneous transmission of at least two partly different contents at the same frequency range.

The segmented content may typically be DOCSIS 3.0/3.1 channels. This is illustrated in FIG. 3 such that the same DVB-C multiplexes (DS1, DS2) are transmitted in both segments. However, the first (upper) segment 306a is provided with DOCSIS multiplexes DS3 and DS4, while the second (lower) segment 306b is provided with multiplexes DS5 and DS6, which may be different DOCSIS multiplexes.

The frequency-limited downstream path of 862 MHz is capable of transmitting four multiplexes and there still remains some bandwidth for RF overlay signals, for example. If RF overlay content is included in the transmission, it can be divided, for example, in a splitter 314 as shown in FIG. 3, and then combined, in addition to the four DVB-C/DOCSIS multiplexes, to both downstream transmissions, for example in segment-specific combiners 316, 318.

It is noted that the downstream path bandwidths of 862 MHz, 1006 MHz and 1.2 GHz mentioned above are only non-limiting examples of some currently used network configurations. A skilled person appreciates that depending on network configuration and as the technology advances, the embodiment described herein may be used for different downstream path bandwidths. As mentioned above, the embodiments are most prominent in frequency-limited network configurations, where the downstream path bandwidth is the bottleneck compared to the maximum output capacity of the RPD/RMD module.

In general, the various embodiments may be implemented in hardware or special purpose circuits or any combination thereof. While various embodiments may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

A skilled person appreciates that any of the embodiments described above may be implemented as a combination with one or more of the other embodiments, unless there is explicitly or implicitly stated that certain embodiments are only alternatives to each other.

The various embodiments can be implemented with the help of computer program code that resides in a memory and causes the relevant apparatuses to carry out the invention. Thus, the implementation may include a computer readable storage medium stored with code thereon for use by an apparatus, such as the network element, which when executed by a processor, causes the apparatus to perform the various embodiments or a subset of them. Additionally or alternatively, the implementation may include a computer program embodied on a non-transitory computer readable medium, the computer program comprising instructions causing, when executed on at least one processor, at least one apparatus to apparatus to perform the various embodiments or a subset of them. For example, an apparatus may comprise circuitry and electronics for handling, receiving and transmitting data, computer program code in a memory, and a processor that, when running the computer program code, causes the apparatus to carry out the features of an embodiment.

It will be obvious for a person skilled in the art that with technological developments, the basic idea of the invention can be implemented in a variety of ways. Thus, the invention and its embodiments are not limited to the above-described examples but they may vary within the scope of the claims.

1. A network element of a cable television (CATV) network, said network element comprising a Remote PHY Device (RPD) or a Remote-MACPHY Device (RMD) node comprising
a core network interface for receiving a plurality of broadcast multiplexes;
a circuit configured to divide the plurality of broadcast multiplexes into at least a first transmission content and a second transmission content, wherein the first and the second transmission content comprise at least partly different DOCSIS multiplexes; and
a circuit configured to transmit the first transmission content to a first network segment and the second transmission content to a second network segment.

2. The network element according to claim 1, wherein said circuit configured to transmit the content comprises a first transmission port for the first network segment and a second transmission port for the second network segment and at least one modulator for modulating the first and the second transmission to same frequency band.

3. The network element according to claim 1, wherein the first and the second transmission content comprise at least one common multiplex.

4. The network element according to claim 3, wherein the at least one common multiplex is a DVB-C multiplex.

5. (canceled)

6. The network element according to claim 1, wherein the first and the second transmission content are provided with RF overlay content.

7. The network element according to claim 6, wherein the network element comprises
a splitter for dividing the RF overlay content into two similar signals; and
a first combiner for combining a divided RF overlay signal with the first transmission content and a second combiner for combining a divided RF overlay signal with the second transmission content.
